(19) United States
(12) Patent Application Publication
(10) Pub. No.: US 2003/0123322 A1
(43) Pub. Date: Jul. 3, 2003

(54) Microfluidic mixer apparatus and microfluidic reactor apparatus for microfluidic processing

(75) Inventors: Yung-Chiang Chung, Hsinchu (TW); Ming-Shiung Jan, Hsinchu (TW); Ju-Hwa Lin, Hsinchu (TW); Shr-Hau Huang, Hsinchu (TW)

Correspondence Address: TUNG & ASSOCIATES, Suite 120, 838 W. Long Lake Road, Bloomfield Hills, MI, 48302, US

(73) Assignee: Industrial Technology Research Institute

(21) Appl. No.: 10/038,994

(22) Filed: Dec. 31, 2001

(51) Int. Cl. B01F 15/02; B01F 13/00

(52) U.S. Cl. 366/165.1; 366/336; 366/341

(57) ABSTRACT

Within each of a microfluidic mixer apparatus and a microfluidic reactor apparatus, as well as respective methods for operation thereof, there is provided a substrate having formed therein an aperture. Within the microfluidic mixer apparatus and its method of operation there is introduced into the aperture at least a pair of reagents through a pair of channels which terminate obliquely at the aperture, such as to provide a swirling mixing of the pair of reagents. Within the microfluidic reactor apparatus, the aperture comprises a first end portion contiguous with a middle portion in turn contiguous with a second end portion, where the middle portion, but not the first end portion or the second end portion, has at least one baffle intruding therein.

### BACKGROUND OF THE INVENTION

1. Field of the Invention

The present invention relates generally to microfluidic apparatus employed for microfluidic processing. More particularly, the present invention relates to microfluidic mixer apparatus and microfluidic reactor apparatus employed for microfluidic processing.

2. Description of the Related Art

Microelectronic fabrications are formed from microelectronic substrates within and upon which are formed microelectronic devices and over which are formed patterned microelectronic conductor layers which are separated by microelectronic dielectric layers.

As an extension of microelectronic fabrication technology, there has recently evolved a branch of technology generally referred to as microelectromechanical system (MEMS) technology. Microelectromechanical system (MEMS) technology generally employs microfabrication techniques which are analogous with those employed within microelectronic fabrication technology, but where a resulting microelectromechanical system (MEMS) product (in comparison with a microelectronic fabrication product) possess microelectromechanical capabilities rather purely microelectronic capabilities or optoelectronic microelectronic capabilities. Within the general field of microelectromechanical system (MEMS) technology considerable interest has arisen in microfluidic microelectromechanical system (MEMS) products which require the fabrication of micro-pumps, micro-valves and micro-channels within a substrate, such as to effect various microfluidic operations within the microfluidic microelectromechanical system (MEMS) products.

Applications of microfluidic microelectromechanical system (MEMS) products are often directed towards testing, evaluating or screening of large numbers of sample material fluids while employing limited volumes of the sample material fluids.

While microfluidic microelectromechanical system (MEMS) products thus provide a basis for several desirable analytical tools which may effect further advances in other technology fields, microfluidic microelectromechanical system (MEMS) products are nonetheless not entirely without problems.

In that regard, microfluidic microelectromechanical system (MEMS) products, and their components, are often difficult to readily fabricate and operate.

It is thus desirable in the art of microfluidic microelectromechanical system (MEMS) technology to provide microfluidic microelectromechanical system (MEMS) components which readily fabricated and operated.

It is towards the foregoing object that the present invention is directed.

Various microfluidic microelectromechanical system (MEMS) products having desirable properties, and components thereof, have been disclosed in the art of microfluidic microelectromechanical system (MEMS) technology.

Included among the microfluidic microelectromechanical system (MEMS) products and components thereof, but not limited among the microfluidic microelectromechanical system (MEMS) products and components thereof, are microfluidic microelectromechanical system (MEMS) products and components thereof disclosed within: (1) Desai et al., in U.S. Pat. No. 5,921,678 (a microfluidic microelectromechanical system (MEMS) mixer component capable of initiating or quenching chemical reactions with intervals as short as 100 microseconds, where the microfluidic microelectromechanical system (MEMS) mixer component comprises a plurality of “T” shaped channels where separate pairs of reagents meet head-on to mix at an apex of a “T” and exit through a base of the “T”); (2) Furcht et al., in U.S. Pat. No. 6,054,277 (a fully integrated microfluidic microelectromechanical system (MEMS) product employed for testing genetic material, where the fully integrated microfluidic microelectromechanical system (MEMS) product provides for separation of genetic material as well as amplification of genetic material); (3) Lee et al., in U.S. Pat. No. 6,146,103 (a magnetohydrodynamic micro-pump and micro-sensor component which may be employed within a microfluidic microelectromechanical system (MEMS) product, wherein the magnetohydrodynamic micro-pump and micro-sensor component may be fabricated provide reversible microfluid flow, as well as microfluid mixing); and (4) Henderson et al., in U.S. Pat. No. 6,258,263 (a microfluidic microelectromechanical system (MEMS) product fabricated such as to provide a liquid chromatograph microfluidic microelectromechanical system (MEMS) product).

The teachings of each of the foregoing references is incorporated herein fully by reference.

Desirable in the art of microfluidic microelectromechanical system (MEMS) technology are additional microfluidic microelectromechanical system (MEMS) components which may be readily fabricated and operated.

It is towards the foregoing object that the present invention is directed.

### SUMMARY OF THE INVENTION

A first object of the present invention is to provide a microfluidic microelectromechanical system (MEMS) component.

A second object of the present invention is to provide the microfluidic microelectromechanical system (MEMS) component in accord with the first object of the present invention, wherein the microfluidic microelectromechanical system (MEMS) component is readily fabricated and operated.

In accord with the objects of the present invention, there is provided by the present invention: (1) a microfluidic mixer apparatus and a method for operating the microfluidic mixer apparatus; and (2) a microfluidic reactor apparatus and a method for operating the microfluidic reactor apparatus.

In accord with the present invention, the microfluidic mixer apparatus of the present invention comprises, in a first instance, a substrate. In addition, the microfluidic mixer apparatus also comprises an aperture formed within the substrate. Finally, the microfluidic mixer apparatus also comprises at least two channels also formed within the substrate such as to terminate at the aperture. Within the microfluidic mixer apparatus in accord with the present invention, the at least two channels which terminate at the aperture terminate obliquely with respect to the aperture such as to effect a swirling mixing of at least two reagents introduced into the aperture through the at least two channels.

The microfluidic mixer apparatus in accord with the present invention contemplates a method for operation of the microfluidic mixer apparatus in accord with the present invention.

Further in accord with the present invention, the microfluidic reactor apparatus of the present invention also comprises, in a first instance, a substrate having formed therein an aperture. In addition, within the microfluidic reactor apparatus in accord with the present invention, the aperture has a first end portion contiguous with a middle portion in turn contiguous with a second end portion. Finally, the microfluidic reactor apparatus of the present invention also comprises at least one baffle protruding into the aperture within the middle portion of the aperture, but not the first end portion of the aperture or the second end portion of the aperture.

The microfluidic reactor apparatus in accord with the present invention contemplates a method for operating the microfluidic reactor apparatus in accord with the present invention.

The present invention provides a pair of microfluidic microelectromechanical system (MEMS) components, wherein each of the pair of microfluidic microelectromechanical system (MEMS) components is readily fabricated and operated.

The present invention realizes the foregoing objects with respect to a microfluidic mixer apparatus component for use within a microelectromechanical system (MEMS) product by fabricating the microfluidic mixer apparatus component, which comprises: (1) a substrate having formed therein an aperture; and (2) at least two channels also formed within the substrate such as to terminate at the aperture, such that the at least two channels which terminate at the aperture terminate obliquely with respect to the aperture such as to effect a swirling mixing of at least two reagents introduced into the aperture through the at least two channels.

The present invention realizes the foregoing object with respect to a microfluidic reactor apparatus component for use within a microelectromechanical system (MEMS) product, where: (1) the microfluidic reactor apparatus also comprises a substrate having formed therein an aperture, further where; (2) the aperture has a first end portion contiguous with a middle portion in turn contiguous with a second end portion, by fabricating within the middle portion of the aperture, but not the first end portion of the aperture or the second end portion of the aperture, at least one baffle which intrudes into the aperture.

### BRIEF DESCRIPTION OF THE DRAWINGS

The objects, features and advantages of the present invention are understood within the context of the Description of the Preferred Embodiments, as set forth below. The Description of the Preferred Embodiments is understood within the context of the accompanying drawings, which form a material part of this disclosure, wherein:

FIG. 1 and FIG. 2 show a schematic plan-view diagram and a schematic cross-sectional diagram illustrating a microfluidic mixing apparatus in accord with a first preferred embodiment of the present invention.

FIG. 3, FIG. 4 and FIG. 5 show a schematic plan-view diagram and a pair of schematic cross-sectional diagrams illustrating a microfluidic reactor apparatus in accord with a second preferred embodiment of the present invention.

### DESCRIPTION OF THE PREFERRED EMBODIMENT

The present invention provides a pair of microfluidic microelectromechanical system (MEMS) components, wherein each of the pair of microfluidic microelectromechanical system (MEMS) components is readily fabricated and operated.

The present invention realizes the foregoing objects with respect to a microfluidic mixer apparatus component for use within a microelectromechanical system (MEMS) product by fabricating the microfluidic mixer apparatus component, which comprises: (1) a substrate having formed therein an aperture; and (2) at least two channels also formed within the substrate such as to terminate at the aperture, such that the at least two channels which terminate at the aperture terminate obliquely with respect to the aperture such as to effect a swirling mixing of at least two reagents introduced into the aperture through the at least two channels.

The present invention realizes the foregoing object with respect to a microfluidic reactor apparatus component for use within a microelectromechanical system (MEMS) product, where: (1) the microfluidic reactor apparatus also comprises a substrate having formed therein an aperture, further where; (2) the aperture has a first end portion contiguous with a middle portion in turn contiguous with a second end portion, by fabricating within the middle portion of the aperture, but not the first end portion of the aperture or the second end portion of the aperture, at least one baffle which intrudes into the aperture.

While the preferred embodiments of the present invention provide: (1) a microfluidic mixing apparatus (and a method for operation of the microfluidic mixing apparatus); and (2) a microfluidic reactor apparatus (and a method for operation of the microfluidic reactor apparatus), wherein each of the foregoing pair of microfluidic apparatus provides particular value within the context of testing, evaluation and screening of pharmaceutical materials and genetic materials (including nucleic acids and proteins) the pair of microfluidic apparatus of the present invention (and their methods for operation thereof) may be employed within microfluidic microelectromechanical systems (MEMS) applications other than pharmaceutical, genetic, biochemical and biomedical applications. Such other applications may include, but are not limited to, agrichemicals formulation applications and materials engineering applications.

### Microfluidic Mixing Apparatus

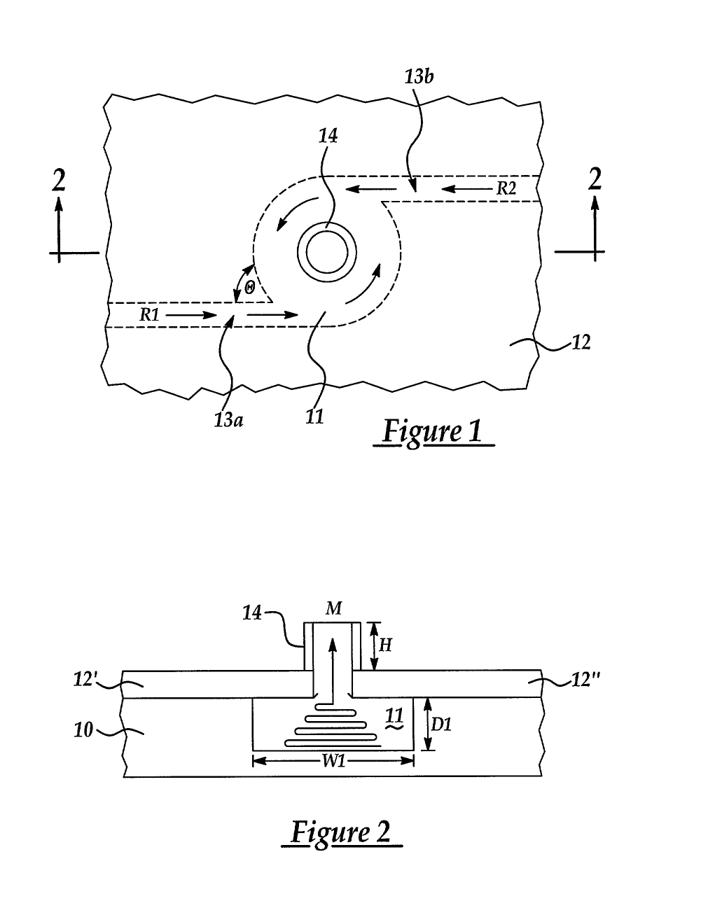

Referring now to FIG. 1 and FIG. 2 there is shown a schematic plan-view diagram and a schematic cross-sectional diagram illustrating a microfluidic mixing apparatus in accord with a first preferred embodiment of the present invention. The microfluidic mixing apparatus may be employed within a microfluidic microelectromechanical system (MEMS) product.

Shown in FIG. 1 is a schematic plan-view diagram of the microfluidic mixing apparatus.

Shown in FIG. 1 is a cover plate 12 which covers a substrate (which is not specifically illustrated) which in part comprises the microfluidic mixing apparatus of the present invention. As is further illustrated within the schematic plan-view diagram of FIG. 1, and as is formed within the substrate beneath the cover plate 12, is an aperture 11 into which in turn terminates at least a pair of reagent supply channels 13a and 13b which is also formed within the substrate. As is further illustrated within the schematic plan-view diagram of FIG. 1, each of the pair of reagent supply channels 13a and 13b terminates at the aperture 11 obliquely such that when a pair of reagents R1 and R2 is introduced into the aperture 11 through the corresponding pair of reagent supply channels 13a and 13b, the pair of reagents R1 and R2 mixes in a swirling fashion. As is finally illustrated within the schematic plan-view diagram of FIG. 1, there is shown an outlet port 14 which allows a mixture of the pair of reagents R1 and R2 to exit from the aperture 11 in a direction perpendicular to a plane of the substrate.

Shown in FIG. 2 is a schematic cross-sectional diagram of a microfluidic mixer apparatus corresponding with the microfluidic mixer apparatus whose schematic plan-view diagram is illustrated in FIG. 1.

Shown in FIG. 2 is the substrate 10 having formed therein the aperture 11. The substrate 10, including the aperture 11, in turn is covered by and has assembled thereto the cover plate 12′/12″, which further in turn has assembled thereto the outlet port 14 from which may exit a mixture M (such as a homogeneous solution) of the reagents R1 and R2 after having been mixed within the aperture 11.

Within the first preferred embodiment of the present invention with respect to the substrate 10, the substrate 10 may be fabricated from a material selected from the group including but not limited to conductor materials, semiconductor materials and dielectric materials, as well as laminates thereof. Within the first preferred embodiment of the present invention, however, the substrate 10 is typically and preferably an inorganic substrate, such as but not limited to a semiconductor substrate, typically and preferably formed to a thickness of from about 4 to about 6 mm. Similarly, within the present invention the cover plate 12 and the outlet port 14 may also be formed from materials selected from the group including but not limited to conductor materials, semiconductor materials and dielectric materials, although within the first preferred embodiment of the present invention both the cover plate 12 and the outlet port 14 are preferably formed of transparent materials, such as but not limited to transparent glass materials, so that operation of the microfluidic mixing apparatus of the first preferred embodiment of the present invention may be visually inspected. Typically and preferably, the cover plate 12 is formed to a thickness of from about 4 to about 6 mm and the outlet port 14 provides a protrusion height H (as illustrated within FIG. 2) upon cover plate 12 of from about 4 to about 6 mm.

Within the preferred embodiment of the present invention with respect to the aperture 11, the aperture 11 typically and preferably has an aperture width W1 (as illustrated within FIG. 2) within the substrate 10 of from about 3 to about 5 mm and an aperture depth D1 (as illustrated within FIG. 2) within the substrate 10 of from about 0.4 to about 0.6 mm. Similarly, although the preferred embodiment of the present invention illustrates the aperture 11 as a circular shaped aperture, within the present invention the aperture 11 may be provided in shapes selected from the group including but not limited to circular shapes, elliptical shapes, irregular continuous sided shapes and polygonal shapes (i.e., discontinuous sided shapes), presuming that at least a pair of reagent supply channels is properly terminally disposed with respect to the aperture such as to effect a swirling mixing of at least a pair of reagents introduced into the aperture, in accord with the present invention.

As is illustrated within the schematic plan-view diagram of FIG. 1, in order to provide the foregoing swirling mixing of the pair of reagents R1 and R2, each of the pair of reagent supply channels 13a and 13b terminates at the aperture 11 with a tangential, oblique and acute angle of incidence θ of from about 20 to about 80 degrees. Additionally, each of the pair of reagent supply channels 13a and 13b is formed of a linewidth within the substrate 10 of from about 0.4 to about 0.6 mm and a depth within the substrate 10 of from about 0.4 to about 0.6 mm. For ease in manufacturing and for more optimal performance, the depth D1 of the aperture 11 within the substrate 10 is typically equivalent with the depth of each of the pair of reagent supply channels 13a and 13b within the substrate 10, although such is not required within the present invention. Finally, although the preferred embodiment of the present invention illustrates the present invention within the context of two reagent supply channels 13a and 13b terminating at the aperture 11, the present invention also contemplates that there may be a greater number of reagent supply channels terminating at the aperture 11. Such an increased number of reagent supply channels will typically and preferably be equally spaced with respect to the periphery of the aperture 11.

Within the first preferred embodiment of the present invention, the aperture 11, as well as the pair of reagent supply channels 13a and 13b, may be formed while employing etching and laminating fabrication methods as are otherwise generally conventional in the art of microfluidic microelectromechanical systems (MEMS) fabrication.

Within the preferred embodiment of the present invention with respect to the outlet port 14, the outlet port 14 is typically and preferably substantially centered (within the limits of fabrication and assembly technology, i.e., within about +/−10% centering uniformity) with respect to the aperture 11, and provided with an outlet port 14 opening linewidth of from about 1 to about 2 mm.

With respect to operation of the microfluidic mixer apparatus of the first preferred embodiment of the present invention as illustrated within the schematic plan-view diagram of FIG. 1 and schematic cross-sectional diagram of FIG. 2, and within the context of the foregoing dimensions for the aperture 11, the pair of reagent supply channels 13a and 13b and the outlet port 14, there is typically and preferably provided a reagent R1 and reagent R2 flow of from about 5 to about 30 microliters per second into the aperture 11, although a reagent R1 flow need not be equivalent with a reagent R2 flow.

Upon fabricating and operating a microfluidic mixer apparatus in accord with the schematic plan-view diagram of FIG. 1 and the schematic cross-sectional diagram of FIG. 2, there is fabricated and operated a microfluidic mixer apparatus in accord with the first preferred embodiment of the present invention. The microfluidic mixer apparatus provides for efficient fabrication and operation insofar as the microfluidic mixer apparatus provides for a swirling mixing of at least two reagents supplied into an aperture which comprises in part the microfluidic mixer apparatus.

### Microfluidic Reactor Apparatus

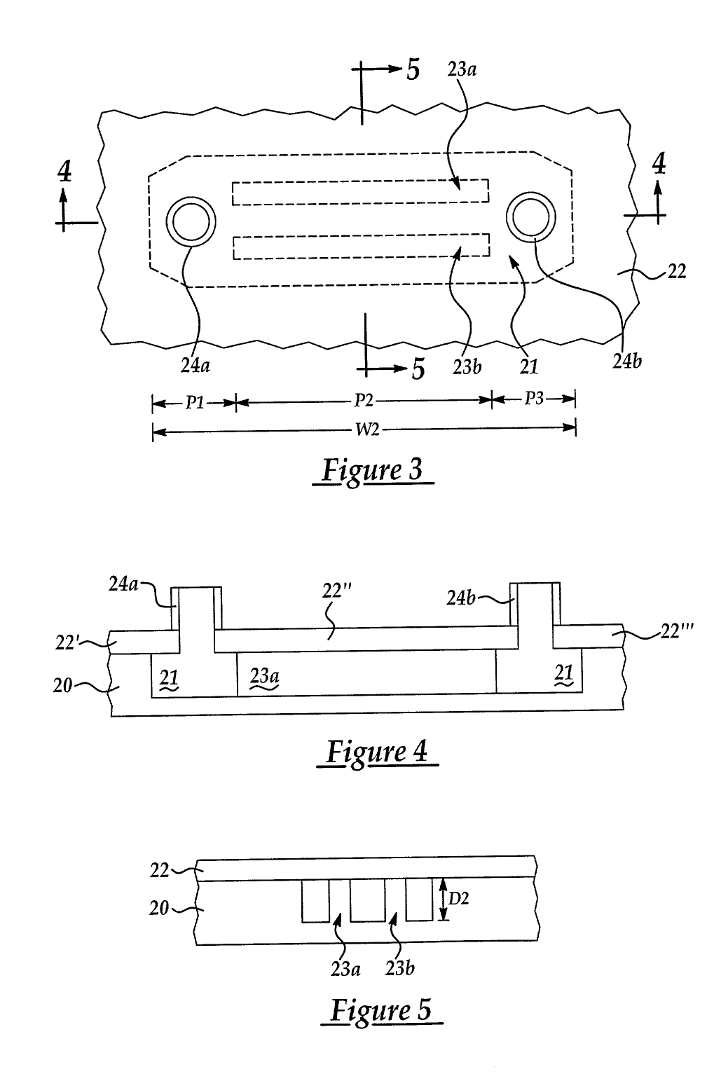

Referring now to FIG. 3 to FIG. 5, there is shown a schematic plan-view diagram and a pair of schematic cross-sectional diagrams illustrating a microfluidic reactor apparatus in accord with a second preferred embodiment of the present invention. The microfluidic reactor apparatus may also be employed within a microfluidic microelectromechanical system (MEMS) product.

Shown in FIG. 3 is a schematic plan-view diagram of the microfluidic reactor apparatus.

Analogously with the microfluidic mixer apparatus whose schematic plan-view diagram is illustrated in FIG. 1, there is shown within the microfluidic reactor apparatus whose schematic plan-view diagram is illustrated in FIG. 3 a cover plate 22 assembled to and covering a substrate (which is also not specifically illustrated), wherein the cover plate 22 in turn has assembled thereto a pair of inlet/outlet ports 24a and 24b. Also similarly with the microfluidic mixer apparatus in accord with the schematic plan-view diagram of FIG. 1 and the schematic cross-sectional diagram of FIG. 2, the microfluidic reactor apparatus as illustrated within the schematic plan-view diagram of FIG. 3 also comprises an aperture 21 formed within the substrate. Within the second preferred embodiment of the present invention, and as illustrated within the schematic plan-view diagram of FIG. 3, the aperture 21 comprises three portions: (1) a first end portion P1, the first end portion P1 being contiguous with; (2) a middle portion P2, the middle portion P2 in turn being contiguous with; (3) a second end portion P3.

As is finally illustrated within the schematic cross-sectional diagram of FIG. 3, the middle portion P2 of the aperture 21, but neither the first end portion P1 of the aperture 21 nor the second end portion P3 of the aperture 21, has formed intruding therein a pair of baffles 23a and 23b. Within the second preferred embodiment of the present invention, the pair of baffles 23a and 23b serves to facilitate operation of the microfluidic reactor apparatus of the second preferred embodiment of the present invention.

Shown in FIG. 4 is a first schematic cross-sectional diagram of a microfluidic reactor apparatus corresponding with the microfluidic reactor apparatus whose schematic plan-view diagram is illustrated in FIG. 3.

Shown in FIG. 4 is the substrate 20 having assembled thereto the cover plate 22′/22″/22′″ in turn having assembled thereto the pair of inlet/outlet ports 24a and 24b. Similarly, the schematic cross-sectional diagram of FIG. 4 also illustrates the aperture 21 having intruding therein the baffle 23a.

Shown in FIG. 5 is a second schematic cross-sectional diagram of a microfluidic reactor apparatus corresponding with the microfluidic reactor apparatus whose schematic plan-view diagram is illustrated in FIG. 3.

Also shown within the schematic cross-sectional diagram of FIG. 5 is the substrate 20 having assembled thereto the cover plate 22. Similarly, and also illustrated within the schematic cross-sectional diagram of FIG. 5 is the pair of baffles 23a and 23b which may derive from incomplete etching of the substrate 20, when forming the aperture 21. Alternatively, or an adjunct, the pair of baffles 23a and 23b may be formed as part of the cover plate 22, or as an independent component which is assembled within the aperture 21 when forming the microfluidic reactor apparatus in accord with the second preferred embodiment of the present invention. Although the pair of baffles 23a and 23b is illustrated as completely spanning from the substrate 20 to the cover plate 22, such is not required within the present invention. Thus, within a microfluidic reactor apparatus in accord with the present invention a series of baffles may provide a series of gaps which separate the series baffles from the substrate 20, the cover plate 22 or both the substrate 20 and the cover plate 22.

Within the second preferred embodiment of the present invention with respect to the substrate 20, the cover plate 22 and the pair of inlet/outlet ports 24a and 24b, the substrate 20, the cover plate 22 and the pair of inlet/outlet ports 24a and 24b may be formed employing materials and dimensions analogous or equivalent to the materials and dimensions employed for forming the substrate 10, the cover plate 12 and the outlet port 14 within the microfluidic mixer apparatus in accord with the first preferred embodiment of the present invention.

Within the second preferred embodiment of the present invention with respect to the aperture 21, the aperture 21 typically and preferably has a longitudinal linewidth W2 (as illustrated in FIG. 3) of from about 500 to about 1000 mm, where the longitudinal linewidth includes the first end portion P1, the middle portion P2 and the second end portion P3 of the aperture 21. Similarly, the first end portion P1 and the second end portion P3 of the aperture 21 each have a longitudinal linewidth of from about 150 to about 250 mm and the middle portion P2 of the aperture has a longitudinal linewidth of from about 400 to about 500 mm. Finally, the aperture 21 typically and preferably has a lateral linewidth within the substrate 20 (which transects the pair of baffles 23a and 23b) of from about 4 to about 6 mm and a depth D2 within the substrate 20 (as illustrated within the schematic cross-sectional diagram of FIG. 5) of from about 0.5 to about 1.5 mm.

Within the preferred embodiment of the present invention with respect to the pair of baffles 23a and 23b, each of the pair of baffles 23a and 23b typically and preferably has a lateral linewidth of from about 0.5 to about 1.5 mm and is separated by a sub-aperture channel distance of from about 0.5 to about 1.5 mm. Although the second preferred embodiment of the present invention illustrates the microfluidic reactor apparatus as comprising the aperture 21 having formed therein two baffles 23a and 23b, a microfluidic reactor apparatus in accord with the present invention may have additional baffles formed within an aperture which comprises the microfluidic reactor apparatus, but will have at least one baffle.

With respect to operation of the microfluidic reactor apparatus of the second preferred embodiment of the present invention, the aperture 21, including the baffles 23a and 23b, typically and preferably has contained therein, and preferably also immobilized therein, a sorbtive material for sorbtion and desorbtion of a sample material of interest which is desired to be separated while employing the microfluidic reactor apparatus in accord with the second preferred embodiment of the present invention. Thus, the microfluidic reactor apparatus of the present invention is typically and preferably employed as a microfluidic liquid chromatography apparatus.

Within the second preferred embodiment of the present invention, the sorbtive material is of a composition as is otherwise generally conventional in the art of liquid chromatography, and the sorbtive material may similarly be immobilized within the aperture 21 and upon the baffles 23a and 23b while employing immobilization methods, such as chemical immobilization methods and physical immobilization methods, as are otherwise generally conventional in the art of liquid chromatograph. When employed for sorbing and separating nucleic acid polymers and protein polymers, sorbants will typically and preferably comprise amino (i.e., −NH2) or cyano (i.e., —CN) functionality. Appropriate commercially available sorbants for such biochemical applications may include, but are not limited to:

(1) MagicBead #1 (Magic Bead Corp.); (2) QIAEX II Suspension #20902 (QIAGEN Corp.); (3) GENECLEAN SPIN GLASSMILK #1101-201 (Q.BIOgene Corp.); and (4) NucleoTrap Suspension #4080-1 (Clontech Corp.).

With respect to operation of the microfluidic reactor apparatus of the present invention, and within the context of aperture 21 and baffle 23a and 23b dimensions disclosed above, there is typically and preferably provided a flow rate of a sample solution through the input/outlet ports 24a and 24b of from about 10 to about 40 microliters per second. Similarly, to facilitate optimal sorbtion of a target material from a sample solution onto a sorbant, the sample solution may be cycled sequentially and reversibly through the microfluidic reactor apparatus of the second preferred embodiment of the present invention.

As is further understood by a person skilled in the art, by fabricating the microfluidic reactor apparatus of the second preferred embodiment of the present invention with the aperture 21 having the first end portion P1 and the second end portion P3 which do not have intruding therein the baffles 23a and 23b, the microfluidic reactor apparatus of the present invention is readily fabricated and operated insofar as the microfluidic reactor apparatus provides minimal difficulty with respect to alignment of the cover plate 22, or the inlet/outlet ports 24a and 24b, with a series of channels defined by the pair of baffles 23a and 23b.

Upon fabricating and operating the microfluidic reactor apparatus of the second preferred embodiment of the present invention, there is provided the microfluidic reactor apparatus which is, for the foregoing reasons, readily fabricated and operated.

As is understood by a person skilled in the art, the preferred embodiments of the present invention are illustrative of the present invention rather than limiting of the present invention. Revisions and modifications may be made to structures and dimensions employed for fabricating a microfluidic mixer apparatus and a microfluidic reactor apparatus in accord with the preferred embodiments of the present invention while still providing a microfluidic mixer apparatus and a microfluidic reactor apparatus in accord with the present invention, further in accord with the accompanying claims.

What is claimed is:

1. An microfluidic mixer apparatus comprising:
a substrate having an aperture formed therein; and
at least two channels also formed within the substrate such as to terminate at the aperture, where the at least two channels which terminate at the aperture terminate obliquely with respect to the aperture such as to effect a swirling mixing of at least two reagents introduced into the aperture through the at least two channels.

2. The microfluidic mixer apparatus of claim 1 further comprising:
a cover plate covering the substrate and the aperture; and
an outlet port assembled to the cover plate and centered over the aperture.

3. The microfluidic mixer apparatus of claim 1 wherein the substrate is formed from a material selected from the group consisting of conductor materials, semiconductor materials and dielectric materials.

4. The microfluidic mixer apparatus of claim 1 wherein the aperture is formed in a geometric shape selected from the group consisting of circular geometric shapes, elliptical geometric shapes, irregular continuous sided geometric shapes and polygonal geometric shapes.

5. A method for operating a microfluidic mixer apparatus comprising:
providing a microfluidic mixer apparatus comprising
a substrate having an aperture formed therein; and
at least two channels also formed within the substrate such as to terminate at the aperture, where the at least two channels which terminate at the aperture terminate obliquely with respect to the aperture such as to effect a swirling mixing of at least two reagents introduced into the aperture through the at least two channels; and
introducing into the aperture the at least two reagents through the at least two channels.

6. The method of claim 5 further comprising:
a cover plate covering the substrate and the aperture; and
an outlet port assembled to the cover plate and centered over the aperture.

7. The method of claim 5 wherein the substrate is formed from a materials selected from the group consisting of conductor materials, semiconductor materials and dielectric materials.

8. The method of claim 5 wherein the aperture is formed in a geometric shape selected from the group consisting of circular geometric shapes, elliptical geometric shapes, irregular continuous sided geometric shapes and polygonal geometric shapes.

9. A microfluidic reactor apparatus comprising:
a substrate having an aperture formed therein, the aperture having a first end portion contiguous with a middle portion in turn contiguous with a second end portion, wherein the middle portion of the aperture, but not the first end portion of the aperture or the second end portion of the aperture, has at least one baffle which intrudes into the aperture.

10. The microfluidic reactor apparatus of claim 9 further comprising:
a cover plate covering the substrate including the aperture; and
a pair of inlet/outlet ports assembled to the cover plate to access the first end portion of the aperture and the second end portion of the aperture.

11. The microfluidic reactor apparatus of claim 9 further comprising a sorbant material immobilized within the aperture including the at least one baffle.

12. The microfluidic reactor apparatus of claim 9 wherein the substrate is formed from a material selected from the group consisting of conductor materials, semiconductor materials and dielectric materials.

13. A method for operating microfluidic reactor apparatus comprising:
providing a microfluidic reactor apparatus comprising:
a substrate having an aperture formed therein, the aperture having a first end portion contiguous with a middle portion in turn contiguous with a second end portion, wherein the middle portion of the aperture, but not the first end portion of the aperture or the second end portion of the aperture, has at least one baffle which intrudes into the aperture; and
introducing a liquid sample into the aperture.

14. The method of claim 13 further comprising:
a cover plate covering the substrate including the aperture; and
a pair of inlet/outlet ports assembled to the cover plate to access the first end portion of the aperture and the second end portion of the aperture.

15. The method of claim 13 further comprising a sorbant material immobilized within the aperture including the at least one baffle.

16. The method of claim 13 wherein the substrate is formed from a material selected from the group consisting of conductor materials, semiconductor materials and dielectric materials.

17. A nucleic acids extraction apparatus comprising:
a substrate having at least one channel formed therein for effecting an extraction of said nucleic acids, said substrate being formed of a material selected from the group consisting of beads and micro-carriers for extracting and immobilizing nucleic acids on surfaces of said at least one channel.

18. A method for extracting nucleic acids comprising the steps of:
providing a nucleic acids extraction apparatus comprising:
a substrate having at least one channel formed therein for effecting an extraction of said nucleic acids, said substrate being formed of a material selected from the group consisting of beads and micro-carriers for extracting and immobilizing nucleic acids on surfaces of said at least one channel; and
flowing a nucleic acid solution into said at least one channel and driving said nucleic acid solution back and forth in said channel.
